(19) United States
(12) Patent Application Publication
(10) Pub. No.: US 2026/0148561 A1
(43) Pub. Date: May 28, 2026

(54) LOST CHILD DETECTION DEVICE AND LOST CHILD DETECTION SYSTEM

(71) Applicant: SoftBank Group Corp., Tokyo (JP)

(72) Inventors: Yuta KIMURA, Tokyo (JP); Naoki KUSUMOTO, Tokyo (JP)

(21) Appl. No.: 19/398,219

(22) Filed: Nov. 24, 2025

(30) Foreign Application Priority Data
Nov. 27, 2024 (JP) 2024-205992
Nov. 11, 2025 (JP) 2025-190322

(51) Int. Cl. G06V 20/52; G06V 40/16; G06V 40/50; H04N 7/18

(52) U.S. Cl. CPC G06V 20/52; G06V 40/171; G06V 40/172; G06V 40/50; H04N 7/181

(57) ABSTRACT

A lost child detection device includes: an acquisition unit configured to, when detecting an entry of a registered subject and a registered guardian who protects the subject into a predetermined area, acquire images of the registered subject and the registered guardian from captured images taken by cameras arranged within a predetermined area; an estimation unit configured to estimate a likelihood of the subject being lost based on the images of the subject and the guardian acquired by the acquisition unit; and an identification unit configured to, when the likelihood of the subject being lost estimated by the estimation unit exceeds a predetermined threshold, identify a location of the subject based on a capture location of the camera.

### CROSS-REFERENCE TO RELATED APPLICATION

The present application claims priority to and incorporates by reference the entire contents of Japanese Patent Application No. 2024-205992 filed in Japan on Nov. 27, 2024 and Japanese Patent Application No. 2025-190322 filed in Japan on Nov. 11, 2025, the entire contents of which are incorporated herein by reference.

### BACKGROUND OF THE INVENTION

### 1. Field of the Invention

The present invention relates to a lost child detection device and a lost child detection system.

### 2. Description of the Related Art

In recent years, a large number of users visit facilities such as large-scale shopping centers. However, many of these users are families with children, and as facilities become larger, cases of children getting lost have increased (see Japanese Unexamined Patent Application Publication No. 2016-152512 and Japanese Unexamined Patent Application Publication No. 2002-101444, for example).

For example, there are many cases where a child accompanied by a guardian, such as a parent, gets lost while the guardian is using the facility. Moreover, a child often cannot state his/her own name or a name of his/her guardian, which results in a significant amount of time required to find the lost child. Therefore, there is a demand for a system that can quickly find, even in a case where a subject such as a child accompanied by his/her guardian within a facility is separated from the guardian, the lost subject.

### SUMMARY OF THE INVENTION

In one embodiment, a lost child detection device includes: an acquisition unit, an estimation unit, and an identification unit. The acquisition unit acquires, when detecting an entry of a registered subject and a registered guardian who protects the subject into a predetermined area, images of the registered subject and the registered guardian from captured images taken by cameras arranged within a predetermined area. The estimation unit estimates a likelihood of the subject being lost based on the images of the subject and the guardian acquired by the acquisition unit. The identification unit identifies, when the likelihood of the subject being lost estimated by the estimation unit exceeds a predetermined threshold, a location of the subject based on a capture location of the camera.

### BRIEF DESCRIPTION OF THE DRAWINGS

FIG. 1 is an explanatory diagram showing an example of a lost child detection system according to a present embodiment.

FIG. 2 is a block diagram showing an example of a hardware configuration of a mobile terminal;

FIG. 3 is a block diagram showing an example of a hardware configuration of a server;

FIG. 4 is a block diagram showing an example of the functional configuration of a server;

FIG. 5 is an explanatory diagram showing an example of a table configuration of a registration memory;

FIG. 6 is an explanatory diagram showing an example of a table configuration of an entry memory;

FIG. 7 is an explanatory diagram showing an example of a table configuration of a real-time image memory;

FIG. 8 is a block diagram showing an example of a hardware configuration of a facility-side terminal;

FIG. 9 is a flowchart showing an example of a processing operation of the server related to registration processing;

FIG. 10 is an explanatory diagram showing an example of a screen of a mobile terminal related to a registration request;

FIG. 11 is an explanatory diagram showing an example of a processing operation of the server for extracting facial images of a guardian and a subject from a provided image;

FIG. 12 is a flowchart showing an example of a processing operation of the server related to monitoring processing;

FIG. 13 is a flowchart showing an example of the processing operation of the server related to monitoring processing.

FIG. 14 is an explanatory diagram showing an example of a processing operation of the server related to facial image recognition at a time of subject entry;

FIG. 15 is an explanatory diagram showing an example of an entry report screen of a facility-side terminal;

FIG. 16 is an explanatory diagram showing an example of a lost child report screen of a facility-side terminal before a protection request;

FIG. 17 is an explanatory diagram showing an example of a lost child notification screen of a mobile terminal; and

FIG. 18 is an explanatory diagram showing an example of a lost child report screen of the facility-side terminal after the protection request.

### DETAILED DESCRIPTION OF THE PREFERRED EMBODIMENTS

Hereinafter, embodiments of the lost child detection device and the like disclosed in the present application will be described in detail with reference to the drawings. Note that the disclosed technology is not limited by the present embodiment. Furthermore, each embodiment described below may be appropriately combined as long as no contradiction arises.

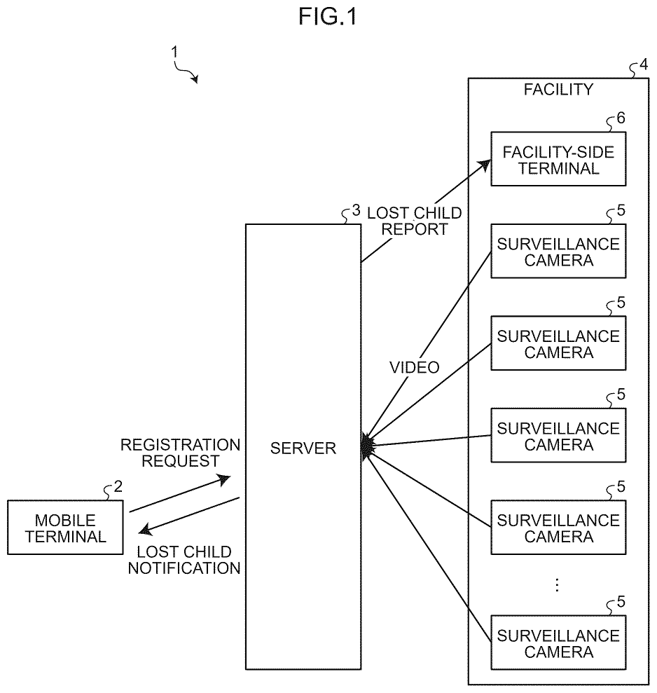

FIG. 1 is an explanatory diagram showing an example of a lost child detection system 1 according to the present embodiment. The lost child detection system 1 shown in FIG. 1 includes a mobile terminal 2, a server 3, a plurality of surveillance cameras 5 in a facility 4, and a facility-side terminal 6 in the facility 4. The facility 4 includes a plurality of surveillance cameras 5 arranged at various locations within the facility and the facility-side terminals 6 carried by a staff patrolling within the facility 4. The mobile terminal 2 is, for example, a terminal device used by a guardian utilizing the facility, such as a smartphone or tablet device equipped with imaging and communication functions. The server 3 is, for example, a subject detection device such as a computer that executes various processes for detecting subjects within the facility 4. The surveillance cameras 5 are cameras arranged at various locations within the facility 4 for capturing video images. The facility-side terminal 6 is a predetermined terminal device, such as a smartphone or tablet device equipped with imaging and communication functions, carried by a staff patrolling within the facility 4. The facility-side terminal 6 may also include a monitoring device installed in a control room or the like of the facility 4.

The mobile terminal 2, the server 3, the surveillance cameras 5, and the facility-side terminal 6 are, for example, capable of wireless communication via a wireless LAN (Local Area Network) router or the like. The mobile terminal 2, for example, transmits a provided image including a guardian and a subject to the server 3 via a wireless LAN router. Needless to say, the mobile terminal 2 can also communicate with the server 3 via a public wireless communication network. The subject may be, for example, a child or elderly person protected by a guardian. The guardian may be, for example, child's parents or related persons. The provided image is an image including a facial image showing features of the guardian and the subject. The server 3 acquires the provided image received from the mobile terminal 2.

When the server 3 detects a registration request from the mobile terminal 2, the server 3 registers facial images and feature information of a guardian and a subject from the registration request. The server 3 identifies the registered guardian and subject from captured images taken by the surveillance cameras 5 installed at the entrance of the facility 4. The server 3 captures real-time video images of the registered guardian and subject who have entered the facility 4 using the surveillance camera 5 in the facility 4. Then, the server 3 estimates a likelihood of a subject being lost from the captured images from the surveillance cameras 5, determines whether the subject is lost based on the estimation result. If the subject is lost, the server 3 notifies a lost child report to the facility-side terminal 6 and also notifies a lost child notification to the guardian's mobile terminal 2 with respect to the guardian. As a result, a staff of the facility-side terminal 6 can recognize possibility of a registered subject being lost, and a guardian using the mobile terminal 2 can also recognize the possibility of the subject being lost.

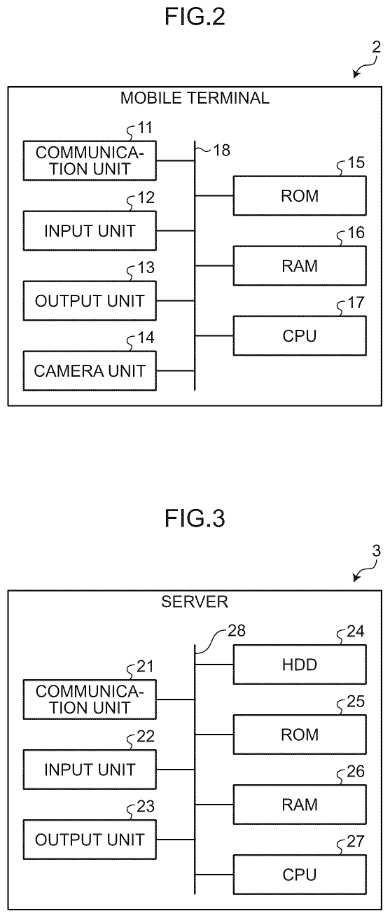

FIG. 2 is a block diagram showing an example of a hardware configuration of the mobile terminal 2. The mobile terminal 2 shown in FIG. 2 includes a communication unit 11, an input unit 12, an output unit 13, a camera unit 14, a ROM (Read Only Memory) 15, a RAM (Random Access Memory) 16, a CPU (Central Processing Unit) 17, and a bus 18. The communication unit 11 is a communication interface (IF) that wirelessly communicates with a wireless LAN router and also with a public wireless communication network. The input unit 12 is an input interface such as an operation device for inputting various types of information. The output unit 13 is an output interface such as an audio output device or display device for outputting various types of information. The camera unit 14, for example, acquires a facial image showing features of a subject. The ROM 15 is an area for storing various types of information, such as programs. The RAM 16 is an area for storing various types of information. The CPU 17 controls the entire mobile terminal 2. The bus 18 is a bus line connecting the communication unit 11, the input unit 12, the output unit 13, the camera unit 14, the ROM 15, the RAM 16, and the CPU 17.

FIG. 3 is a block diagram showing an example of a hardware configuration of the server 3. The server 3 shown in FIG. 3 includes a communication unit 21, an input unit 22, an output unit 23, an HDD (Hard Disk Drive) 24, a ROM 25, a RAM 26, a CPU 27, and a bus 28. The communication unit 21 is a communication interface (IF) that wirelessly connects to a wireless LAN router and also wirelessly communicates with a public wireless communication network. The input unit 22 is an input interface such as an operation device for inputting various types of information. The output unit 23 is an output interface such as an audio output device or display device for outputting various types of information. The HDD 24 is an area for storing various types of information. The ROM 25 is an area for storing various types of information, such as programs. The RAM 26 is an area for storing various types of information. The CPU 27 controls the entire server 3. The bus 28 is a bus line connecting the communication unit 21, the input unit 22, the output unit 23, the HDD 24, the ROM 25, the RAM 26, and the CPU 27.

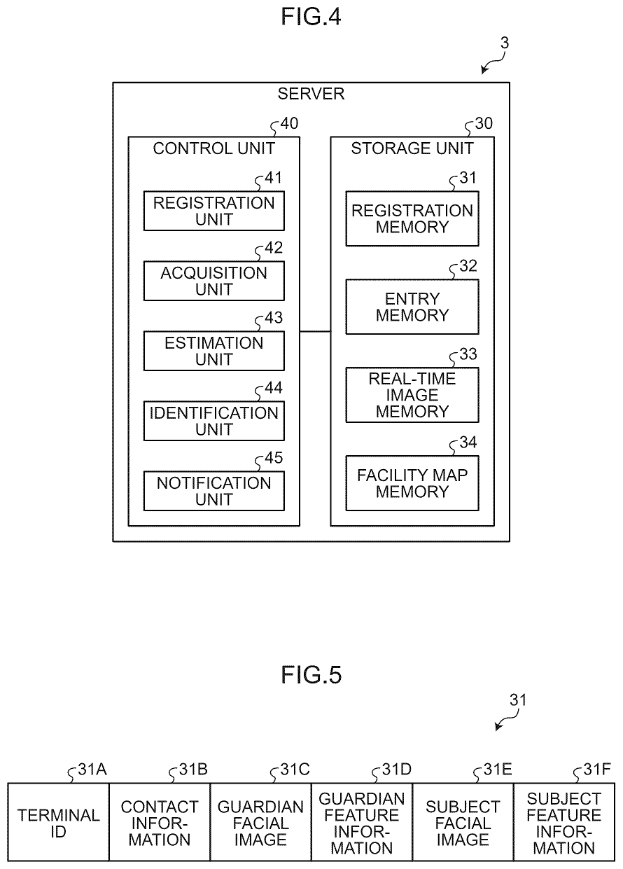

FIG. 4 is a block diagram showing an example of a functional configuration of the server 3. The server 3 shown in FIG. 4 includes a storage unit 30 and a control unit 40. The storage unit 30 corresponds to, for example, a semiconductor memory device such as the RAM 26 or a flash memory, or a storage device such as the HDD 24 or an optical disk. The storage unit 30 includes a registration memory 31, an entry memory 32, a real-time image memory 33, and a facility map memory 34. The registration memory 31 stores information including facial images and feature information of a subject and a guardian. The entry memory 32 stores information at a time of entry, including captured images of a registered subject and guardian taken at a time of entry into the facility 4. The real-time image memory 33 stores information including captured images of a registered subject and guardian within the facility 4. The facility map memory 34 stores a map of the facility 4 in which a capture ranges of the surveillance cameras 5 installed in the facility 4 can be identified.

The surveillance cameras 5 in this system are installed at different locations within the facility 4, and position information of each surveillance camera 5 is stored in association with the facility map memory 34. The facility map memory 34 retains installation coordinates and capture ranges of each of the surveillance cameras 5 in an identifiable manner. The control unit 40 refers to the facility map memory 34 and integrally manages the camera position information within the facility.

The control unit 40 corresponds to an electronic circuit such as the CPU 27. The control unit 40 has an internal memory for storing programs and control data that define various processing procedures, so as to execute various processes. The CPU 27, for example, deploys a program stored in the ROM 25 onto the RAM 26. By executing the program deployed on the RAM 26 as a process, the CPU 27 functions as, for example, a registration unit 41, an acquisition unit 42, an estimation unit 43, an identification unit 44, and a notification unit 45. The registration unit 41, before the subject enters the facility 4, registers information including facial images and feature information of the guardian and the subject in the registration memory 31 in response to a registration request from the guardian's mobile terminal 2. The feature information includes, for example, a name, an age, a gender, and external features for identifying a person.

The acquisition unit 42 manages image data captured by each of the surveillance cameras 5 in association with corresponding camera position information. The identification unit 44 refers to the camera position information of the captured image corresponding to a subject determined by the estimation unit 43 to have a likelihood of being lost exceeding a predetermined threshold, and identifies a location of the subject based on the position information. In this way, by integrally managing position information of the plurality of surveillance cameras 5 installed in a facility and identifying a location of a subject based on association with captured images, a lost child can be found quickly and with high accuracy.

When the acquisition unit 42 detects a captured image of a person at an entrance of the facility 4, the acquisition unit 42 detects entry of a registered guardian and subject into the facility 4 if facial images of the registered guardian and subject are present in the captured image. When the acquisition unit 42 detects entry of a guardian and subject into the facility 4, the acquisition unit 42 acquires images and feature information such as facial images of a registered subject and guardian at a time of entry from captured images taken by each of the surveillance cameras 5 installed in the facility 4. Then, the acquisition unit 42 registers facial images and feature information of a subject and guardian at a time of entry in the entry memory 32. Based on the facial images of the subject registered in the entry memory 32, the acquisition unit 42 acquires in real time a captured video including a image of the registered subject and registers the acquired captured image including the image of the subject in the real-time image memory 33. Based on the facial images of the guardian registered in the entry memory 32, the acquisition unit 42 acquires in real time the captured image including the image of the registered guardian and registers the acquired captured image including the image of the guardian in the real-time image memory 33.

The estimation unit 43 estimates a likelihood of a subject being lost based on expressions and behaviors of the subject and guardian in captured images acquired by the acquisition unit 42, as well as a distance between the subject and the guardian. For example, the estimation unit 43 estimates a likelihood of a subject being lost using generative AI. The estimation unit 43 updates the estimated likelihood of the subject being lost in the real-time image memory 33.

The estimation unit 43 inputs feature quantities such as behavioral features, distance information, and expression information of a subject and guardian obtained by the acquisition unit 42 into a neural network trained based on training data, and calculates a likelihood of a subject being lost. With such a configuration, unlike conventional rule-based determination using distance thresholds, statistical and learning-based estimation processing by AI enables quick and highly accurate detection of lost children.

In addition, the estimation unit 43 can use a generative model in addition to a classification model. The generative model may include a configuration that reconstructs normal behavior patterns while accompanied by a guardian and detects abnormal (lost) states by evaluating a reconstruction error.

Specifically, the estimation unit 43 extracts position coordinates, behavior vectors, facial expression features, and surrounding crowd density information of a subject and guardian from continuous image data acquired by the acquisition unit 42. The estimation unit 43 includes a classification model that classifies a likelihood of a subject being lost using a trained neural network with the above-mentioned multiple feature quantities as input. Furthermore, the estimation unit 43 utilizes a feature space of normal behavior patterns constructed by a generative model in addition to the classification model. Specifically, a generative AI model (for example, an autoencoder or diffusion model) that reconstructs a time-series behavior of a subject based on normal behavior data while accompanied by a guardian in a facility is used, and if a reconstruction error exceeds a threshold, it is determined to be an abnormal lost state.

In this way, the estimation unit 43 has a hybrid configuration that combines direct state determination by a classification model and deviation evaluation from normal behavior by a generative model. This enables highly accurate discrimination between situations where a subject is temporarily separated from a guardian and actual abnormal states where the subject is lost.

The identification unit 44 determines whether a likelihood of a subject being lost estimated by the estimation unit 43 exceeds a predetermined threshold, for example, 80%. When a likelihood of a subject being lost exceeds the predetermined threshold, the identification unit 44 identifies a location of the subject based on a capture location of the surveillance camera 5.

The notification unit 45 outputs a notification of a location of a subject identified by the identification unit 44. The notification unit 45 outputs a lost child report including the location of the subject to the facility-side terminal 6 and also outputs a lost child notification including possibility of the subject being lost to the guardian's mobile terminal 2. In addition, the generative AI may, for example, determine whether a likelihood of a subject being lost exceeds a predetermined threshold, and, if the likelihood of the subject being lost exceeds the predetermined threshold, execute functions of the identification unit 44 for identifying the location of the subject from the capture location, and the notification unit 45 for outputting a notification of the identified location of the subject, and may be appropriately modified.

FIG. 5 is an explanatory diagram showing an example of a table configuration of the registration memory 31. The registration unit 41 in the server 3 registers contents of the registration memory 31 in response to a registration request from the mobile terminal 2. The registration memory 31 shown in FIG. 5 stores, for each terminal ID 31A, contact information 31B, guardian facial image 31C, guardian feature information 31D, subject facial image 31E, and subject feature information 31F. The terminal ID 31A is an ID for identifying the guardian's mobile terminal 2. The contact information 31B is the contact information of the guardian, such as the phone number of the mobile terminal 2. The guardian facial image 31C is a facial image showing features of the guardian, extracted from the provided image. The guardian feature information 31D is information for confirming identity of the guardian, including, for example, a guardian's name, gender, age, and external features. The external features can be obtained from a guardian's facial image. The subject facial image 31E is a facial image showing features of the subject, for example, a child protected by the guardian, extracted from a provided image. The subject feature information 31F is information for confirming identity of the subject, including, for example, a subject's name, gender, age, and external features. The external features can be obtained from a subject's facial image.

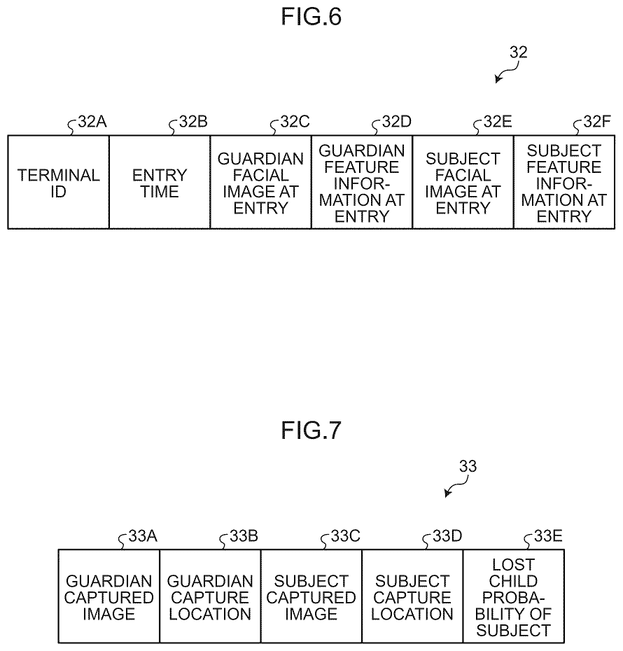

FIG. 6 is an explanatory diagram showing an example of a table configuration of the entry memory 32. The acquisition unit 42 in the server 3 registers contents of the entry memory 32 in response to detection of entry of a subject and guardian into the facility 4. The entry memory 32 shown in FIG. 6 stores, for each terminal ID 32A, entry time 32B, guardian facial image at entry 32C, guardian feature information at entry 32D, subject facial image at entry 32E, and subject feature information at entry 32F. The terminal ID 32A is an ID for identifying the registered guardian's mobile terminal 2. The entry time 32B is a time when a registered guardian and subject are detected to have entered the facility 4, for example, a time when a registered guardian and subject are recognized in a captured image taken by the surveillance camera 5 at an entrance of the facility 4.

The guardian facial image at entry 32C is a facial image of a guardian at a time of entry, extracted from the captured video of the surveillance camera 5 at an entrance of the facility 4. The guardian feature information at entry 32D is feature information of a guardian at a time of entry, extracted from a captured video of the surveillance camera 5 at the entrance of the facility 4. The feature information includes, for example, age, gender, and external features such as clothing, hairstyle, and hair color. The subject facial image at entry 32E is a facial image of a subject at a time of entry, extracted from a captured video of the surveillance camera 5 at an entrance of the facility 4. The subject feature information at entry 32F is a feature information of a subject at a time of entry, extracted from a captured video of the surveillance camera 5 at an entrance of the facility 4. The feature information includes, for example, age, gender, and external features such as clothing, hairstyle, and hair color.

FIG. 7 is an explanatory diagram showing an example of a table configuration of the real-time image memory 33. After the acquisition unit 42 in the server 3 detects an entry of a subject and guardian into the facility 4, it registers captured images of the subject and guardian within the facility 4 in the real-time image memory 33. The real-time image memory 33 shown in FIG. 7 stores guardian captured image 33A, guardian capture location 33B, subject captured image 33C, subject capture location 33D, and subject lost child probability 33E.

The guardian captured image 33A is a current captured image of a guardian within the facility 4 taken by the surveillance camera 5. The guardian capture location 33B is a capture location of the surveillance camera 5 currently capturing a guardian's image. The subject captured image 33C is a current captured image of a subject taken by the surveillance camera 5. The subject capture location 33D is a capture location of the surveillance camera 5 currently capturing a subject's image. The subject lost child probability 33E represents a likelihood of a subject being lost, estimated by the estimation unit 43, as a percentage.

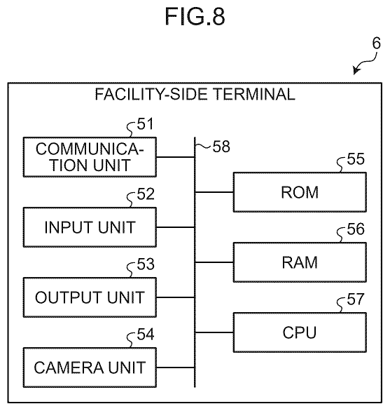

FIG. 8 is a block diagram showing an example of a hardware configuration of the facility-side terminal 6. The facility-side terminal 6 shown in FIG. 8 includes a communication unit 51, an input unit 52, an output unit 53, a camera unit 54, a ROM 55, a RAM 56, a CPU 57, and a bus 58. The communication unit 51 is a communication interface (IF) that wirelessly communicates with a wireless LAN router and also with a public wireless communication network. The input unit 52 is an input interface such as an operation device for inputting various types of information. The output unit 53 is an output interface such as an audio output device or display device for outputting various types of information. The camera unit 54, for example, acquires a facial image showing features of a subject in order to confirm identity of the subject after a staff carrying the facility-side terminal 6 finds the lost subject. The ROM 55 is an area for storing various types of information, such as programs. The RAM 56 is an area for storing various types of information. The CPU 57 controls the entire facility-side terminal 6. The bus 58 is a bus line connecting the communication unit 51, the input unit 52, the output unit 53, the camera unit 54, the ROM 55, the RAM 56, and the CPU 57.

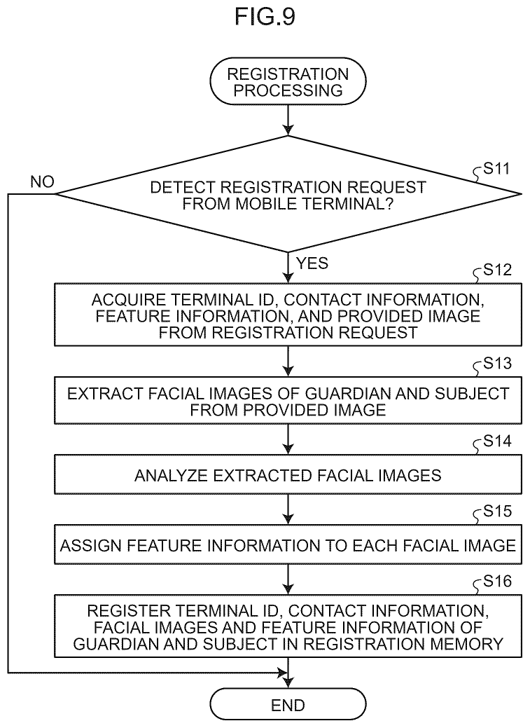

Next, operations of the lost child detection system 1 of the present embodiment will be described. FIG. 9 is a flowchart showing an example of a processing operation of the server 3 related to registration processing. In FIG. 9, the registration unit 41 in the server 3 determines whether a registration request has been detected from the mobile terminal 2 (step S11). A registration request includes, for example, a terminal ID for identifying the mobile terminal 2, contact information, feature information of a subject and guardian, and a provided image including facial images of the subject and guardian.

When the registration unit 41 detects a registration request from the mobile terminal 2 (step S11: Yes), the registration unit 41 acquires a terminal ID, contact information, feature information of a subject and guardian, and a provided image from the registration request (step S12). The registration unit 41 extracts facial images of the guardian and subject from the provided image, respectively (step S13). The registration unit 41 analyzes external features of the guardian and subject from the extracted facial images (step S14).

The registration unit 41 recognizes a guardian and subject based on the external features obtained from the analysis results. Based on the recognition results of the guardian and subject, the registration unit 41 assigns feature information of the guardian to a guardian's facial image and feature information of the subject to a subject's facial image (step S15). Then, for each terminal ID, the registration unit 41 registers contact information, facial images of the guardian and subject, and feature information of the guardian and subject in the registration memory 31 (step S16), and ends the processing operation shown in FIG. 9.

If the registration unit 41 does not detect a registration request from the mobile terminal 2 (step S11: No), the processing operation shown in FIG. 9 is terminated.

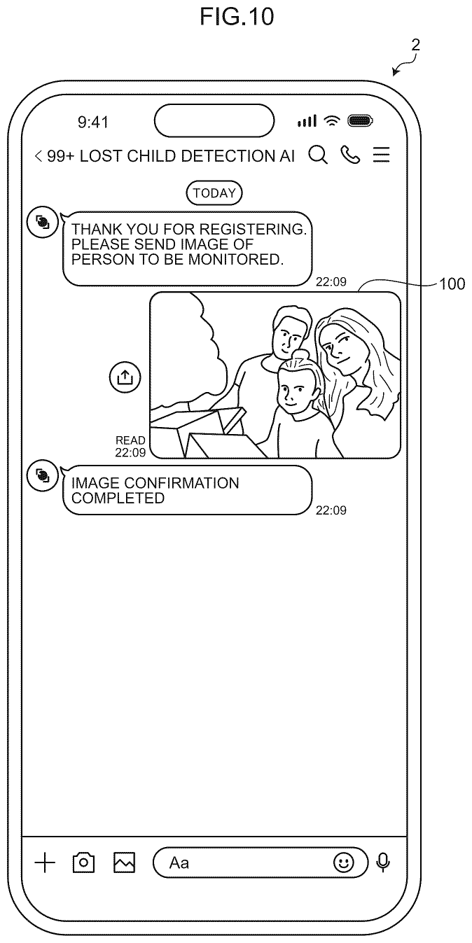

FIG. 10 is an explanatory diagram showing an example of a screen of the mobile terminal 2 related to a registration request. When the mobile terminal 2 shown in FIG. 10 detects a registration request to the server 3, the mobile terminal 2 receives a message from the server 3 stating, “Thank you for registering. Please send an image of a person to be monitored.” The mobile terminal 2 transmits a provided image 100 including facial images of a guardian and subject to the server 3. Then, the server 3 extracts facial images of the guardian and subject and part of feature information from the provided screen, registers the extracted information in the registration memory 31, and then sends a message indicating completion of image confirmation to the mobile terminal 2.

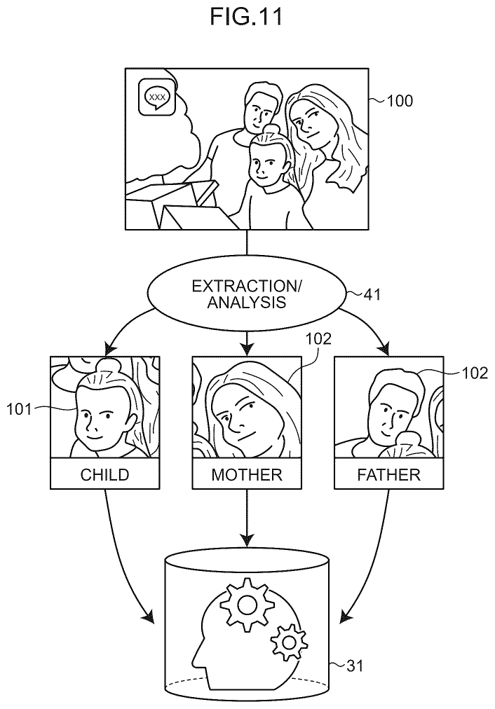

FIG. 11 is an explanatory diagram showing an example of a processing operation of the server 3 for extracting facial images of a guardian and subject from a provided image. When the registration unit 41 in the server 3 acquires the provided image 100 from the mobile terminal 2, the registration unit 41 extracts facial images 101 and 102 from the provided image 100. The registration unit 41 analyzes external feature information from the extracted facial images 101 and 102 and recognizes a guardian and subject. Based on the recognition results of the guardian and subject, the registration unit 41 assigns feature information of the guardian to the guardian's facial image 102 and feature information of the subject to the subject's facial image 101. The registration unit 41 registers the guardian's facial image and feature information and the subject's facial image and feature information in the registration memory 31. Note that the registration of the guardian's facial image and feature information and the subject's facial image and feature information may be performed by acquiring the provided image of the guardian and the provided image of the subject, respectively.

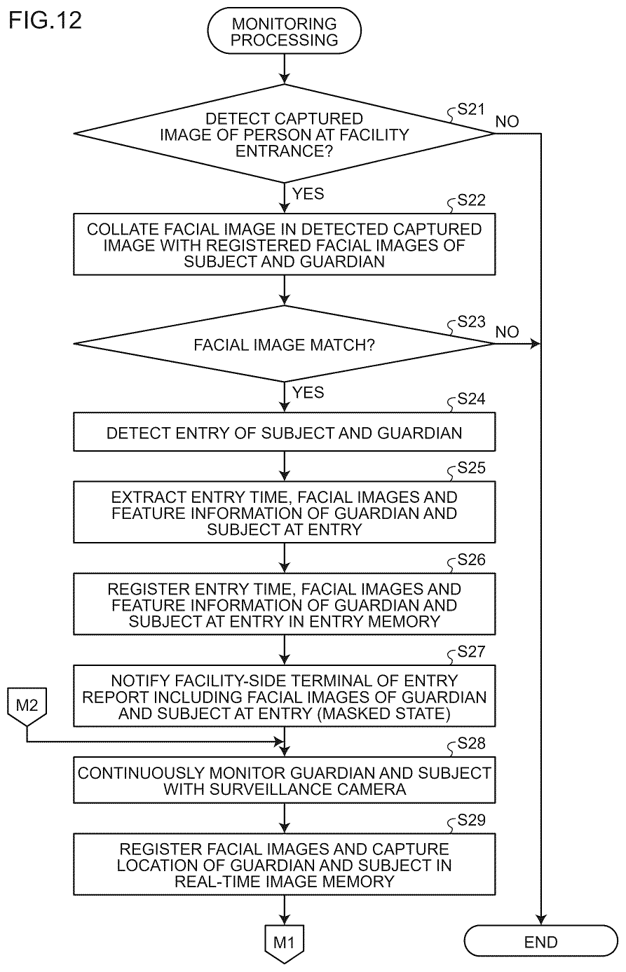

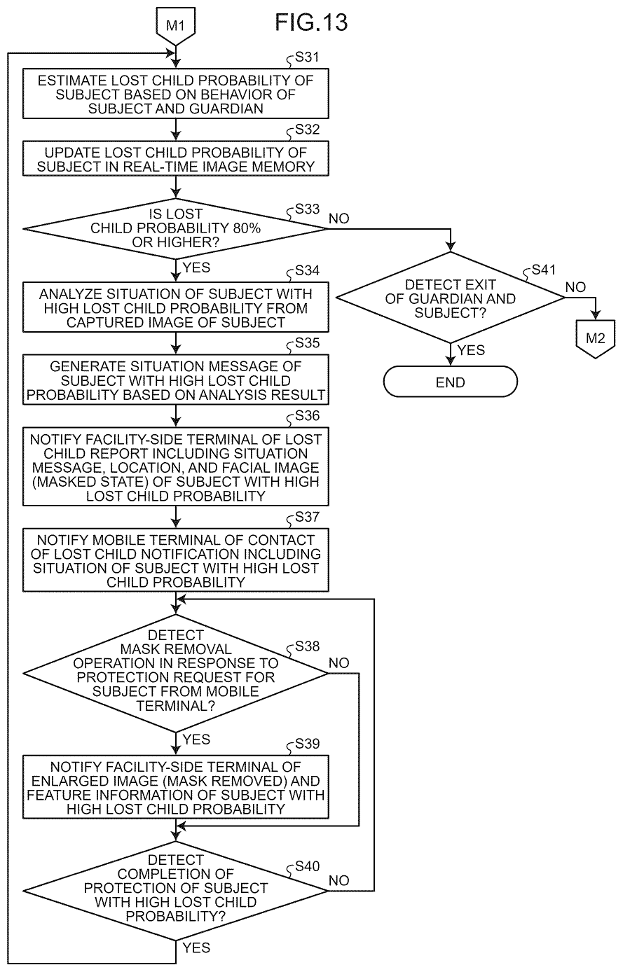

FIGS. 12 and 13 are flowcharts showing examples of a processing operation of the server 3 related to monitoring processing. In FIG. 12, the acquisition unit 42 in the server 3 determines whether a captured image of a person has been detected by the surveillance camera 5 at an entrance of the facility 4 (step S21). When the acquisition unit 42 detects a captured image of a person (step S21: Yes), the acquisition unit 42 collates a facial image in the detected captured image with facial images of a registered subject and guardian stored in the registration memory 31 (step S22).

Based on the collation result, the acquisition unit 42 determines whether the facial image in the captured image matches facial images of the registered subject and guardian (step S23). If the facial image in the captured image matches the facial images of the registered subject and guardian (step S23: Yes), the acquisition unit 42 determines that the registered subject and guardian have entered the facility 4 (step S24).

After detecting entry of a registered subject and guardian, the acquisition unit 42 extracts facial images and feature information of the subject and guardian at a time of entry from the captured images taken by the surveillance camera 5 at an entrance of the facility 4, in addition to the entry time (step S25).

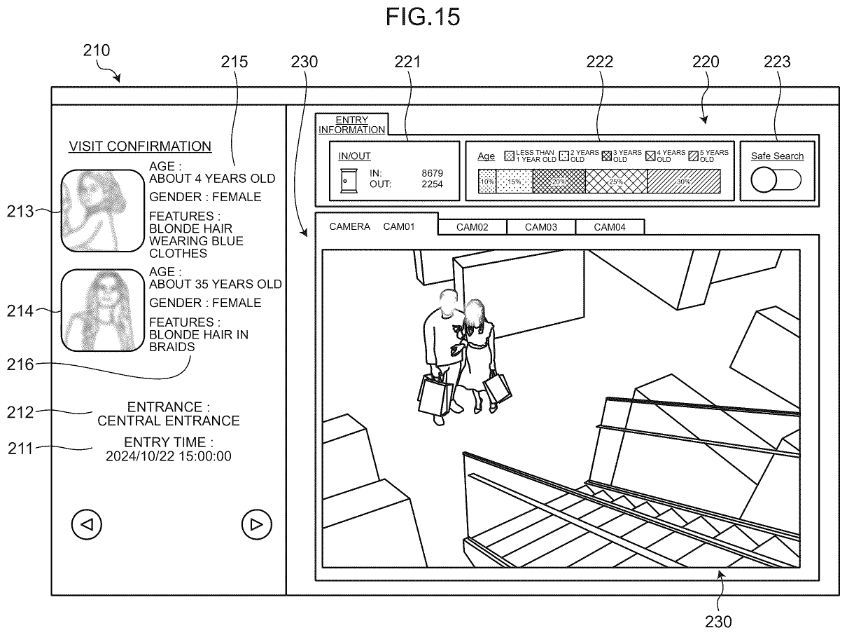

The acquisition unit 42 registers an entry time, facial images of a subject and guardian at the time of entry, and feature information at the time of entry in the entry memory 32 (step S26). Then, the notification unit 45 in the server 3 notifies the facility-side terminal 6 of the entry report including the registered entry time, the facial images of the subject and guardian at the time of entry, and the feature information at the time of entry (step S27). The facility-side terminal 6 displays the entry report screen shown in FIG. 15 in response to the entry report. As a result, a staff of the facility-side terminal 6 can recognize the entry of the subject and guardian by viewing an entry report screen. However, for privacy protection, the facial images of the subject and guardian at the time of entry displayed on the entry report screen displayed on a display of the facility-side terminal 6 are masked.

Then, the control unit 40 in the server 3 continuously monitors a guardian and subject with each of the surveillance cameras 5 (step S28), registers captured images including facial images of the guardian and subject and capture locations in the real-time image memory 33 (step S29), and transitions to M1 shown in FIG. 13. If the acquisition unit 42 does not detect a captured image of a person (step S21: No), or if a facial image in a captured image does not match facial images of the registered subject and guardian (step S23: No), the processing operation shown in FIG. 12 is terminated.

In M1 shown in FIG. 13, the estimation unit 43 in the server 3 estimates a likelihood of a subject being lost based on a behavior of the subject and guardian extracted from captured images and a distance between the subject and guardian (step S31). The estimation unit 43 updates the estimated likelihood of the subject being lost in the real-time image memory 33 (step S32).

The identification unit 44 in the server 3 determines whether a likelihood of a subject being lost is 80% or higher (step S33). If the likelihood of the subject being lost is 80% or higher (step S33: Yes), the identification unit 44 analyzes the situation of the subject with a high likelihood of being lost from the captured images (step S34). The situation of the subject with a high likelihood of being lost refers to state information such as, for example, “There is a possibility that a girl around 4 years old is lost near a children's clothing section on the first floor,” based on a series of captured images of the subject and guardian.

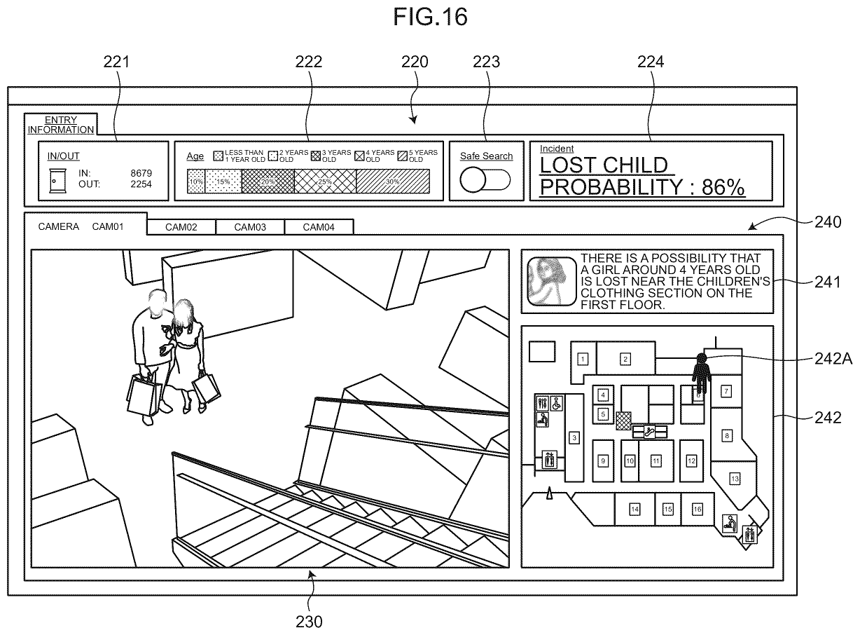

The notification unit 45 in the server 3 generates a situation message of a subject with a high likelihood of being lost based on analysis result of a situation of the subject with a high likelihood of being lost (step S35). The situation message is, for example, a message reported to the facility-side terminal 6 such as “There is a possibility that a girl around 4 years old is lost near a children's clothing section on the first floor.” The notification unit 45 notifies the facility-side terminal 6 of a lost child report including a situation message, a location of the subject, and a facial image of the subject (step S36). When the facility-side terminal 6 detects a lost child report, it displays a lost child report screen shown in FIG. 16. As a result, a staff of the facility-side terminal 6 can recognize a location and situation of the subject with a high likelihood of being lost by viewing the lost child report screen. However, for privacy protection, the facial image of the subject displayed on the lost child report screen of the facility-side terminal 6 is masked.

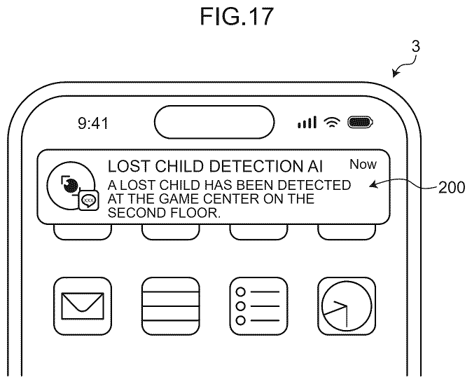

The notification unit 45 notifies the guardian's mobile terminal 2 of a lost child notification including a situation of the subject with a high likelihood of being lost (step S37). When the guardian's mobile terminal 2 detects the lost child notification, the guardian's mobile terminal 2 displays a lost child notification screen shown in FIG. 17. As a result, the guardian using the mobile terminal 2 can recognize a likelihood of a subject being lost by viewing the lost child notification screen. The control unit 40 determines whether a mask removal operation corresponding to a protection request for the subject from the mobile terminal 2 has been detected (step S38). The protection request for a subject is a command requesting the staff of the facility-side terminal 6 to protect the subject. The staff of the facility-side terminal 6 can enable the mask removal button 223 on the lost child report screen in response to a protection request for the subject, and can execute a mask removal operation in response to a button operation. For convenience of explanation, an example is given in which a mask on the lost child report screen is removed in response to a button operation of the mask removal button 223. However, the server 3 may notify the facility-side terminal 6 of a lost child report screen with a mask removed in response to a protection request from the guardian's mobile terminal 2, and this may be appropriately modified.

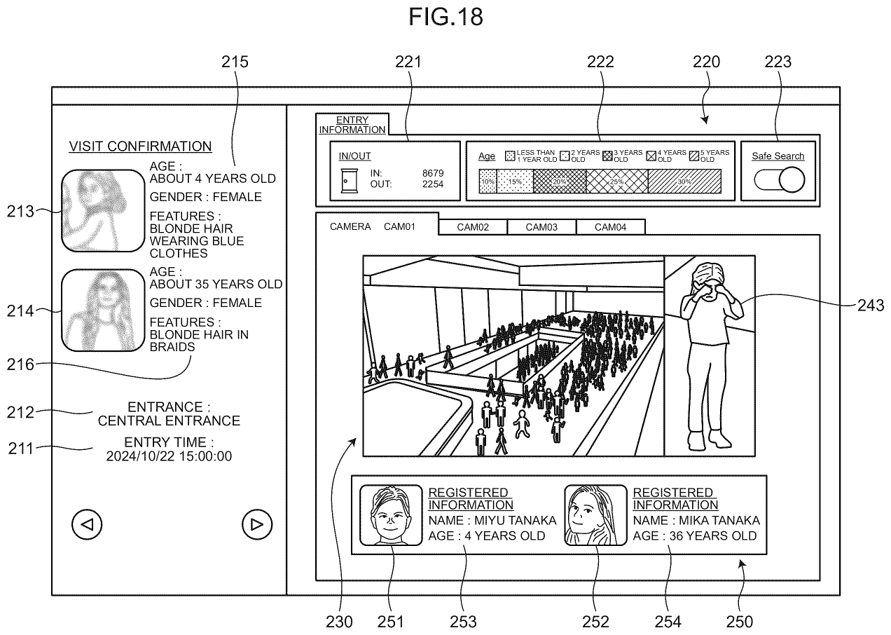

When the notification unit 45 detects a mask removal operation (step S38: Yes), the notification unit 45 notifies the facility-side terminal 6 of a lost child report including an enlarged image of a subject with the mask removed and the feature information of the registered subject and guardian (step S39). When the facility-side terminal 6 detects a lost child report, the facility-side terminal 6 displays a lost child report screen shown in FIG. 18. As a result, a staff of the facility-side terminal 6 can recognize an enlarged image of the subject with a high likelihood of being lost with the mask removed, facial images and feature information of the registered subject and guardian, and so on, by viewing the lost child report screen. Then, by viewing the lost child report screen, the staff of the facility-side terminal 6 can smoothly protect the subject and hand over the subject to his/her guardian.

The control unit 40 determines whether protection of a subject with a high likelihood of being lost has been completed (step S40). The protection completion indicates that the staff has completed protection of the subject. When the control unit 40 detects completion of protection of the subject with a high likelihood of being lost (step S40: Yes), the control unit 40 proceeds to the processing of step S31 for estimating a likelihood of a subject being lost.

If a likelihood of a subject being lost is not 80% or higher (step S33: No), the control unit 40 determines whether the guardian and subject have exited the facility 4 (step S41). The exit of the guardian and subject is determined, for example, by a declaration from the guardian's mobile terminal 2. If the guardian and subject have exited (step S41: Yes), the processing operation shown in FIG. 13 is terminated.

If the notification unit 45 does not detect a mask removal operation (step S38: No), the notification unit 45 proceeds to the processing of step S40 to determine whether protection of a subject with a high likelihood of being lost has been completed. If the control unit 40 has not detected completion of protection of a subject with a high likelihood of being lost (step S40: No), it proceeds to the processing of step S38 to determine whether a mask removal operation has been detected. If a guardian and subject have not exited (step S41: No), the control unit 40 proceeds to the processing of step S28 to continue monitoring the guardian and subject.

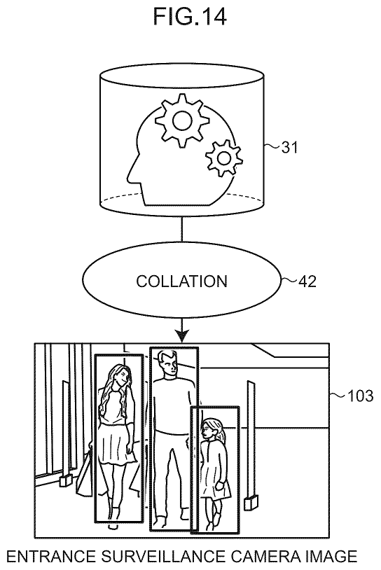

FIG. 14 is an explanatory diagram showing an example of a processing operation of the server 3 related to facial image recognition at a time of subject entry. The acquisition unit 42 in the server 3 shown in FIG. 14 collates a captured image taken by the surveillance camera 5 at an entrance of the facility 4 with facial images and feature information of a registered guardian and subject stored in the registration memory 31. If the captured image matches the facial images of the registered guardian and subject, the acquisition unit 42 determines that the registered guardian and subject have entered the facility 4. Then, the acquisition unit 42 registers an entry time, facial images of the subject and guardian at the time of entry, and feature information at the time of entry in the entry memory 32.

FIG. 15 is an explanatory diagram showing an example of an entry report screen of the facility-side terminal 6. The facility-side terminal 6 displays an entry report screen in response to an entry report from the server 3. The entry report screen of the facility-side terminal 6 shown in FIG. 15 displays visit confirmation information 210, entry information 220, and captured image 230. The visit confirmation information 210 includes an entry time 211, an entry location 212, a guardian facial image at entry 214, guardian feature information at entry 216, a subject facial image at entry 213, and subject feature information at entry 215. The entry time 211 is a time when a guardian and subject entered the facility 4. The entry location 212 is, for example, an entrance of the facility 4. The guardian facial image at entry 214 is a facial image of a guardian extracted from a captured image at the time of entry. The guardian feature information at entry 216 is feature information of a guardian extracted from a captured image at the time of entry. The subject facial image at entry 213 is a facial image of a subject extracted from the captured image at the time of entry. The subject feature information at entry 215 is feature information of a subject extracted from a captured image at a time of entry. At this time, facial images of a guardian and subject at a time of entry are masked for privacy protection.

The entry information 220 includes, in addition to the number information 221 indicating the number of guardians and subjects who have entered the facility 4 and the number of guardians and subjects who have exited the facility 4, an age ratio 222 of children who are currently subjects in the facility 4, and a mask removal button 223. The mask removal button 223 is an operation button for removing the mask set on a screen.

The captured image 230 is a captured image of a registered subject being captured in real time and a captured video of a registered guardian being captured in real time. At this time, facial images of the guardian and subject in the captured video are masked for privacy protection.

FIG. 16 is an explanatory diagram showing an example of a lost child report screen of the facility-side terminal 6 before a protection request. The facility-side terminal 6 displays a lost child report screen in response to a lost child report from the server 3. A lost child report screen of the facility-side terminal 6 shown in FIG. 16 displays, in addition to the entry information 220 and the captured image 230, the lost child information 240. The entry information 220 includes a lost child probability 224 in addition to the number information 221, the age ratio 222, and the mask removal button 223. The lost child probability 224 is a likelihood of a subject being lost estimated by the estimation unit 43.

The lost child information 240 includes a lost child situation message 241 and lost child location information 242. The lost child situation message 241 is a message indicating a situation of a registered subject whose lost child probability is above a predetermined threshold. The lost child location information 242 is information indicating, as the location 242A of a subject, a location of a registered subject whose lost child probability is above a predetermined threshold on a map of the facility 4. The map of the facility 4 is a map generated based on map data of the facility map memory 34.

FIG. 17 is an explanatory diagram showing an example of a lost child notification screen of the mobile terminal 2. The mobile terminal 2 displays a lost child notification screen in response to a lost child notification from the server 3. A lost child notification screen of the guardian's mobile terminal 2 shown in FIG. 17 displays lost child information 200 of a subject. The lost child information 200 is information indicating a situation of a subject being lost.

FIG. 18 is an explanatory diagram showing an example of a lost child report screen of the facility-side terminal 6 after a protection request. After detecting a button operation of the mask removal button 223 following a protection request, the facility-side terminal 6 displays a lost child report screen with a mask removed. The lost child report screen of the facility-side terminal 6 shown in FIG. 18 displays, in addition to the visit confirmation information 210, entry information 220, and subject captured image 230; an enlarged image 243 of the subject and registered information 250 of the registered subject and guardian.

The enlarged image 243 of a subject is an enlarged image of the subject for whom a protection request has been made, among captured images of the surveillance cameras 5. The enlarged image 243 is an image of a subject with a mask removed.

The registered information 250 includes the facial image 251 and feature information 253 of the registered subject registered in the registration memory 31, and the facial image 252 and feature information 254 of the registered guardian registered in the registration memory 31. The facial images 251 of a registered subject and the facial images 252 of a registered guardian are facial images with a mask removed. The feature information 253 of a registered subject and the feature information 254 of a registered guardian include, for example, information such as a name, a gender, an age, and external features. As a result, a staff can smoothly identify and protect a lost subject while viewing a lost child report screen, and can smoothly hand over the subject to the guardian. Therefore, it is possible to improve the safety and security of a shopping environment for facility users and enhance user satisfaction.

When the server 3 detects an entry of a registered subject and guardian into the facility 4, the server 3 acquires images of a registered subject and guardian from captured images taken by the surveillance cameras 5 installed in the facility 4. The server 3 estimates a likelihood of a subject being lost based on the acquired images of the subject and guardian, and, when the estimated likelihood of the subject being lost exceeds a predetermined threshold, identifies a location of the subject from a capture location. As a result, the server 3 can quickly locate a subject with a high likelihood of being lost within the facility 4. With such a configuration, unlike conventional rule-based determination using distance thresholds, statistical and learning-based estimation processing by AI enables quick and highly accurate detection of lost children.

The server 3, based on a facial image of the registered subject stored in the registration memory 31, acquires an image of the registered subject from a captured video, and, based on a facial image of a registered guardian, acquires an image of the registered guardian from the captured video. As a result, the server 3 can recognize the registered guardian and subject who have entered the facility 4.

When the server 3 identifies a location of a subject, it notifies the facility-side terminal 6 of a lost child report including an image of the subject with a facial image masked and a location of the subject. When the facility-side terminal 6 receives the lost child report, it displays a lost child report screen shown in FIG. 16, including an image of the subject with a facial image masked. As a result, a staff can recognize a location of the subject with a high likelihood of being lost. In addition, privacy of the subject with a high likelihood of being lost can be protected.

When the server 3 identifies a location of the subject, it notifies the registered guardian's mobile terminal 2 of a lost child notification including a situation of the subject. When the mobile terminal 2 detects the lost child notification, it displays a lost child notification screen shown in FIG. 17. As a result, a guardian can recognize a likelihood of the subject being lost by viewing the lost child notification screen.

When the server 3 detects a protection request from the guardian's mobile terminal 2, the server 3 notifies the facility-side terminal 6 of a lost child report including an image of a subject with a facial image unmasked and a location of the subject. When the facility-side terminal 6 receives the lost child report, the facility-side terminal 6 displays a lost child report screen shown in FIG. 18, including an image of the subject with a facial image unmasked. As a result, a staff can smoothly identify and protect the lost subject by viewing the lost child report screen, and can smoothly hand over the subject to his/her guardian.

The server 3 manages image data captured by each surveillance camera 5 in association with corresponding camera position information. The server 3 refers to camera position information of a captured image corresponding to a subject determined by the estimation unit 43 to have a likelihood of being lost exceeding a predetermined threshold, and identifies a location of the subject based on the position information. As a result, by integrally managing position information of the plurality of surveillance cameras 5 installed in a facility and identifying a location of a subject based on the association with captured images, a lost child can be found quickly and with high accuracy.

In this embodiment, since a registered guardian and subject are continuously monitored in real time from entry to exit within the facility 4, when it is recognized that the subject is in contact with a third party other than the guardian, a notification may be sent to the guardian's mobile terminal 2 or the facility-side terminal 6. This can prevent abduction of the subject within the facility 4. In addition, the estimation unit 43, in addition to the subject's expression and behavior in the captured images, may focus on a behavior of a third party approaching the subject, estimate not only a likelihood of the subject being lost but also a likelihood of abduction, and output a notification to the mobile terminal 2 or the facility-side terminal 6 based on the likelihood of abduction.

In addition, since the server 3 registers captured images of a guardian and subject in the real-time image memory 33 for each capture location, it is possible to track movement trajectories of guardian and subject in chronological order. As a result, the server 3 can recognize not only movement trajectories of the guardian and subject from entry to exit within the facility 4, but also notify the facility-side terminal 6 and the guardian's mobile terminal 2 of the movement trajectories of the subject and guardian.

For convenience of explanation, the embodiment illustrates a case where a subject detection device is executed by the server 3, but it may be executed in the cloud, and estimation of a likelihood of a registered subject being lost and the identification of a subject's location may be performed in the cloud, and this may be appropriately modified. In addition, the subject detection device may estimate a likelihood of a registered subject being lost and identify a subject's location using an application on the mobile terminal 2 instead of the server 3, and this may be appropriately modified. The subject detection device may be installed in the facility 4. For example, the server 3 or a part of functions thereof may be installed in the facility 4.

Registration of facial images and feature information of a guardian and subject may be performed after entry into the facility 4. In this case, the registered guardian and subject are identified from captured images taken by the surveillance camera 5 after registration.

Although the case where the mobile terminal 2 is wirelessly connected to the server 3 via wireless LAN is illustrated, it is not limited to wireless LAN, and may be wirelessly connected by, for example, Bluetooth (registered trademark), and this may be appropriately modified.

In the above embodiment, a case where a facial image showing features of a subject is registered in the registration memory 31 is illustrated, but it is not limited to a facial image, and any image that can identify features of the subject from the captured image may be used, and this may be appropriately modified.

Although the case where the server 3 executes as a subject detection device is illustrated, for example, the surveillance camera 5 may be an AI camera, and the surveillance camera 5 may execute functions of the acquisition unit 42, estimation unit 43, identification unit 44, and notification unit 45; and this may be appropriately modified.

In addition, respective components of each unit shown in the drawings are not necessarily physically configured as illustrated. That is, specific forms of distribution and integration of each unit are not limited to those shown in the drawings, and all or a part thereof may be functionally or physically distributed or integrated in any unit according to various loads and usage conditions.

Furthermore, various processing functions performed by each device may be executed in whole or in a part on a CPU (Central Processing Unit) (or a microcomputer such as an MPU (Micro Processing Unit) or MCU (Micro Controller Unit)). Needless to say, the various processing functions may be executed in whole or in a part on a program analyzed and executed by a CPU (or a microcomputer such as an MPU or MCU) or on hardware by wired logic.

In addition, various processes described in the embodiment may be realized by executing a pre-prepared program on an information processing device, and this may be appropriately modified.

The various processes according to this embodiment may be realized by executing a program by an information processing device. For example, each function such as the estimation unit 43, identification unit 44, and notification unit 45 described above is realized by a processor reading and executing a program stored in memory.

Furthermore, this embodiment can also be implemented as a lost child detection method for executing the above processes. This lost child detection method may include: (1) a step of acquiring images of a subject and guardian; (2) a step of estimating a likelihood of the subject being lost based on the acquired images;
(3) a step of identifying a location of the subject based on an estimation result; and
(4) a step of notifying an identification result.

Furthermore, this embodiment can also be implemented as an electronic device (or computer device) for executing the above lost child detection method. The electronic device includes at least a processor, a memory, and a communication unit; and realizes each of the above steps by the processor executing a program stored in the memory.

Furthermore, this embodiment can also be implemented as a storage medium recording a program for causing a computer to execute the above lost child detection method. The storage medium may include, for example, a hard disk, a semiconductor memory, an optical disk, etc.; and the above functions are realized by the computer reading and executing the program.

Furthermore, this embodiment can also be implemented as a virtual device that virtually integrates and manages a plurality of cameras and servers installed in real space, and the same functional configuration may be realized in a virtual environment executed on a server or in the cloud.

What is claimed is:

1. A lost child detection device comprising:
an acquisition unit configured to, when detecting an entry of a registered subject and a registered guardian who protects the subject into a predetermined area, acquire images of the registered subject and the registered guardian from captured images taken by cameras arranged within a predetermined area;
an estimation unit configured to estimate a likelihood of the subject being lost based on the images of the subject and the guardian acquired by the acquisition unit; and
an identification unit configured to, when the likelihood of the subject being lost estimated by the estimation unit exceeds a predetermined threshold, identify a location of the subject based on a capture location of the camera.

2. The lost child detection device according to claim 1, further comprising:
a registration unit configured to register, before the subject and the guardian enter the predetermined area, facial images of the subject and the guardian and identification information for identifying the subject and the guardian, wherein
the acquisition unit is configured to:
based on the facial image of the registered subject registered by the registration unit, acquire an image of the registered subject from the captured image; and
based on the facial image of the registered guardian, acquire an image of the registered guardian from the captured image.

3. The lost child detection device according to claim 2, further comprising:
a notification unit configured to, when the identification unit identifies a location of the subject, notify a facility-side terminal of the location of the subject including an image in which the facial image of the subject is masked.

4. The lost child detection device according to claim 3, wherein
the notification unit is configured to, when the identification unit identifies the location of the subject, notify a terminal of the registered guardian of the situation of the subject.

5. The lost child detection device according to claim 4, wherein
the notification unit is configured to, when a protection request from the guardian's terminal is detected, notify a facility-side terminal of a location of the subject including an image in which the facial image of the subject is unmasked.

6. The lost child detection device according to claim 4, wherein
the notification unit is configured to, when a protection request from the guardian's terminal is detected, notify a facility-side terminal of a location of the subject including an image in which the facial image of the subject is unmasked and identification information of the registered guardian and the registered subject.

7. A lost child detection system comprising:
a guardian's terminal storing an image of a subject;
a lost child detection device configured to register the image of the subject when a request to register the image of the subject is detected from the guardian's terminal; and
a predetermined terminal within a predetermined area, wherein
the lost child detection device comprises:
an acquisition unit configured to, when detecting an entry of a registered subject and a registered guardian who protects the subject into the predetermined area, acquire images of the registered subject and the registered guardian from captured images taken by cameras arranged within the predetermined area;
an estimation unit configured to estimate a likelihood of the subject being lost based on the images of the subject and the guardian acquired by the acquisition unit;
an identification unit configured to, when the likelihood of the subject being lost estimated by the estimation unit exceeds a predetermined threshold, identify a location of the subject based on a capture location of the camera; and
a notification unit configured to output a notification of the location of the subject identified by the identification unit to the predetermined terminal, and the predetermined terminal comprises an output unit configured to output the location of the subject notified by the notification unit.
